(19) United States
(12) Patent Application Publication
(10) Pub. No.: US 2009/0027793 A1
(43) Pub. Date: Jan. 29, 2009

(54) COLOR WHEEL

(75) Inventor: YU-LUN HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/946,440

(22) Filed: Nov. 28, 2007

(30) Foreign Application Priority Data
Jul. 27, 2007 (CN) 200710201199.4

(51) Int. Cl. G02B 7/00; G02B 5/22

(52) U.S. Cl. 359/892; 359/891

(57) ABSTRACT

A color wheel includes a motor, a color filter, and an obstructing plate. The motor includes a body, a rotating disk with a rotating shaft protruding outward from the center of a side of the rotating disk. The color filter includes filter sectors colored red, green, and blue, respectively. The contacting borders of the filter sectors are adhered to each other by glue and cooperatively form a through hole. The color filter is fixedly mounted on the rotating shaft, thereby the color filter can rotate together with the rotating shaft. Each of the filter sectors defines an extending segment extending from an edge thereof near the center of the color filter cooperatively forming a mounting ring. The obstructing plate defines an opening in the middle thereof to fixedly receive the mounting ring therein.

### TECHNICAL FIELD

The present invention relates to the art of a color wheel and, particularly, to a color wheel used in a projection display device.

### BACKGROUND

Digital Light Processing (DLP) is a widely used projection technology. DLP has several advantages, including high brightness, accurate tone reproduction, fast response time, and thin and light composition.

In a DLP projector, a digital control method and a reflection principle are adopted. Light rays from the light source are collected and focused by the lenses to pass through three color filters. Then, the light rays are projected onto a Digital Micro-mirror Device (DMD). Since the DMD includes several movable micro mirrors, driving electrodes may control the tilt angle and deflection time of each movable mirror. Then, the light rays are projected to form an image by switching the direction of the light rays reflections.

Referring to FIGS. 7-8, a related color wheel 100 used in the DLP projector includes a motor 20 and a color filter 10 pivotally engaged to the motor with glue 30. The motor 20 includes a rotating disk 21 and a rotating shaft 22 perpendicularly protruding outward from the middle of a side 23 adjacent to the color filter 10. The color filter 10 is circular and includes filter sectors 101, 103 and 105 colored red, green, and blue respectively. The contacting borders (not labeled) of each of the filter sectors 101, 103, and 105 are connected to each other by glue 30, thereby the filter sectors 101, 103, and 105 cooperatively form an opening 102, to receive the corresponding rotating shaft 22 of the motor 20 therein. Each of the filter sectors 101, 103, and 105 has a glue area 104 with a same diameter as the side 23 of the motor 20 and is adhered to the side 23 by the glue 30, thereby the engagement between the color filter 10 and the motor 20 is obtained.

However, because of consumer demand for compact design, projectors have been miniaturized so that the color wheel is also becoming smaller and smaller. Therefore, when high temperature light beams are transmitted through the downsized color filter 10 and the color filter 10 rotates at a high-speed, heat is rapidly conducted through the contacting borders between the filter sectors 101, 103, and 105 and can breakdown glue 30. Thus, engagement between the color filter 10 and the motor 20 is unreliable. In addition, if the centrifugal force acting on the contacting borders of the filter sectors 101, 103, and 105 during rotation is greater than the strength of the adherence between the contacting borders, the filter sectors 101, 103, and 105 are easy to radially separate from each other.

What is needed, therefore, is a color wheel that can prevent the filter sectors thereof from separating during high speed rotation.

### SUMMARY

In accordance with a present embodiment, a color wheel includes a motor, a color filter, and an obstructing plate. The motor includes a body, and a rotating disk with a rotating shaft protruding outward from the center of a side of the rotating disk. The color filter includes a plurality of filter sectors, such as red, green and blue. The contacting borders of the filter sectors are adhered to each other by a glue to cooperatively form a through hole. The color filter is fixedly mounted on the rotating shaft, thereby the color filter can rotate together with the rotating shaft. Further, each pair of the adjoining sides of the filter sectors is glued together cooperatively forming a mounting ring. The obstructing plate defines an opening in the middle thereof to fixedly receive the mounting ring therein. The diameter of the mounting ring is equal to that of the opening. During high speed rotation of the color wheel, even if the centrifugal force acting on the contacting borders of the filter sectors is greater than the strength of adherence between the contacting borders of the filter sectors, the filter sectors can not radially separate from each other because of the obstructing plate fixedly positioning the color filter.

Other advantages and novel features will be drawn from the following detailed description of at least one preferred embodiment, when considered in conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the color wheel. Moreover, in the drawings, like reference numerals designate corresponding parts throughout the several views.

FIG. 1 is an exploded cross-sectional view of a color wheel in accordance with a first present embodiment.

FIG. 2 is an assembled view of FIG. 1.

FIG. 3 is a lateral view of a color filter of FIG. 1.

FIG. 4 is an exploded, cross-sectional view of a color wheel in accordance with a second present embodiment.

FIG. 5 is an assembled view of FIG. 4.

FIG. 6 is a lateral view of a color filter of FIG. 4.

FIG. 7 is an cross-sectional assembled view of a related color wheel.

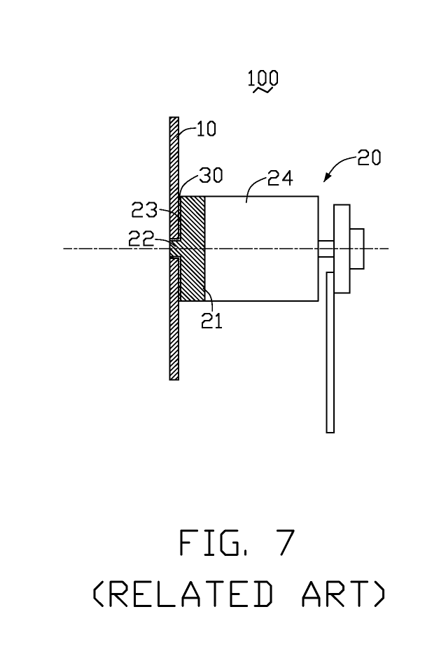

FIG. 8 is a lateral view of FIG. 7.

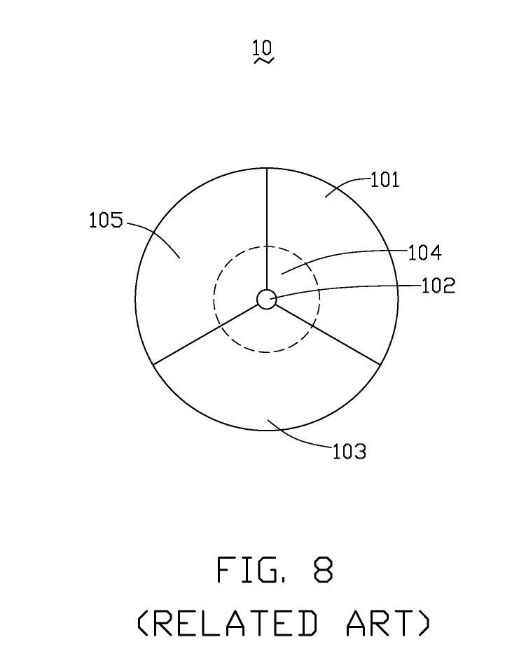

### DESCRIPTION OF EMBODIMENTS

Embodiments of the present color wheel will now be described in detail below with reference to the drawings.

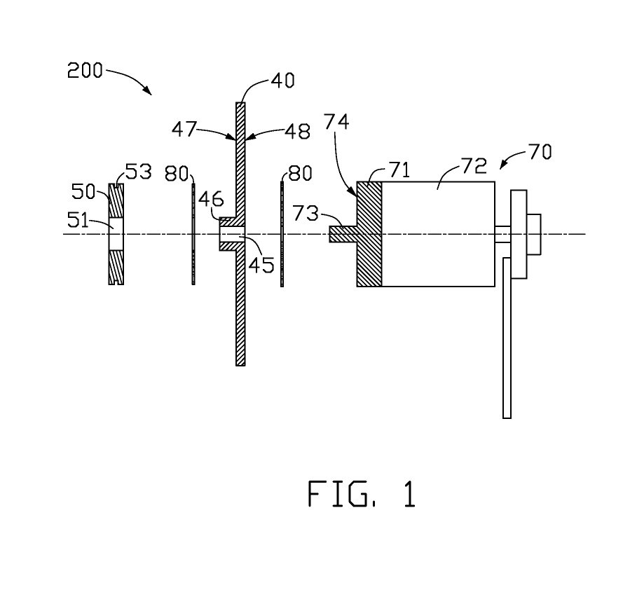

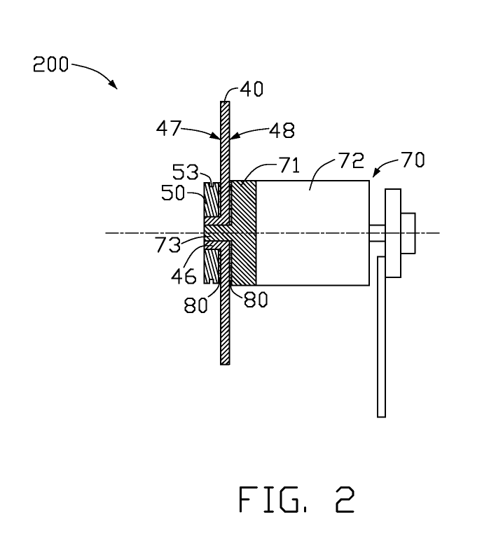

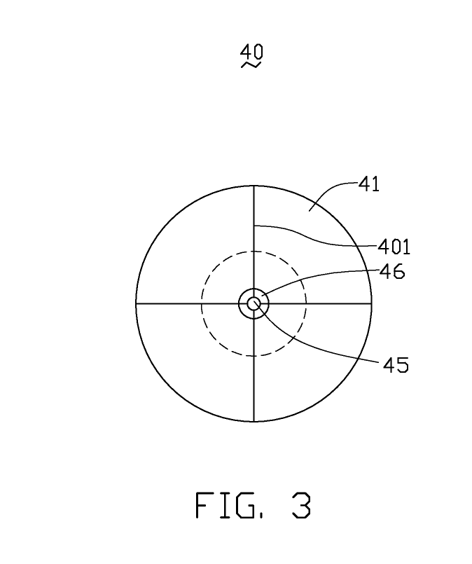

Referring to FIGS. 1-3, a color wheel 200, in accordance with a first preferred embodiment, includes a color filter 40, an obstructing plate 50, and a motor 70.

The color filter 40 is a transparent plate-configuration, beneficially, made from glass or quartz. The color filter 40 includes a plurality of filter sectors 41, such as red, green and blue. The contacting borders 401 of the filter sectors 41 are adhered to each other by a glue 80 and cooperatively form a through hole 45. The color filter 40 defines a first surface 47, a second surface 48 opposite to the first surface 47, and the through hole 45 formed in the middle thereof. The second surface 48 is formed adjacent to the motor 70, while the first surface 47 is formed away from the motor 70. Each filter sector 41 includes a base plate (not labeled) and an extending segment (not labeled). The extending segments cooperate to form a mounting ring 46 extending peripherally away from the first surface 47 from the edge of the filter sector 41 nearest the center of the first surface 47 of the base plate to define the through hole 45.

The motor 70 has a body 72, a rotating disk 71 with a rotating shaft 73 protruding from a side 74 of the center axis of the rotating disk 71. The side 74 is adjacent to the second surface 48 of the color filter 40. The diameter of the rotating shaft 73 is equal to that of the through hole 45 of the color filter 40, while the length of the rotating shaft 73 along the center axis of the rotating disk 71 is also equal to that of the through hole 45.

The obstructing plate 50 is ring-shaped and defines an opening 51 corresponding to the mounting ring 46 of the color filter 40. The diameter of the opening 51 is approximately equal to the diameter of the mounting ring 46, while the length of the opening 51 along the center axis of the rotating shaft 73 is equal to that of the mounting ring 46. On the periphery of the positioning plate 50, a recess 53 with a balancing device (not shown) that can adjustably balance the color wheel 200 during high-speed rotation is formed.

When assembling the color wheel 200, the color filter 40 is firstly engaged with the motor 70 not only by the rotating shaft 73 of the motor 70 being inserted into the through hole 13 and adhered to the sides thereof, but also the glue area of the second surface 48 is adhered to the side 74 of the motor 70. Then, the subassembly of the color filter 40 and the motor 70 is engaged with the obstructing plate 50 not only by the mounting ring 46 being inserted into the opening 51 and adhered to the sides thereof, but also the obstructing plate 50 is adhered to the first surface 47 of the color filter 40, thereby reliably positioning of the color filter 40 arranged between the obstructing plate 50 and the motor 70 is obtained. Thus the assembly of the color wheel 200 is completed.

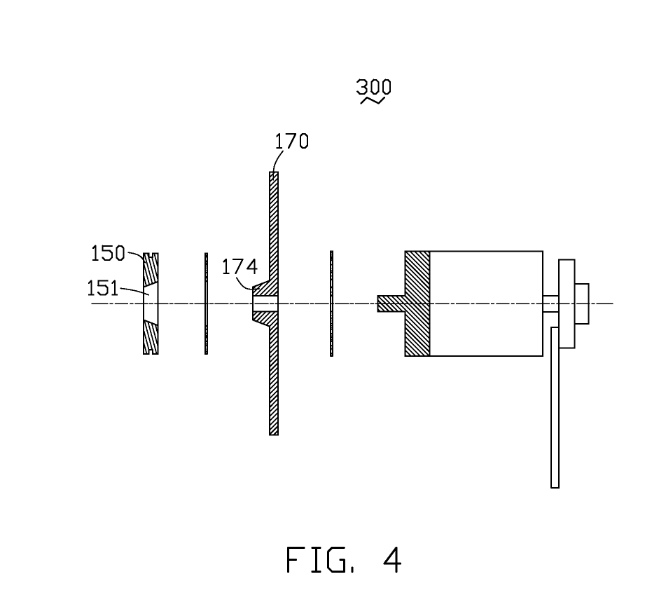

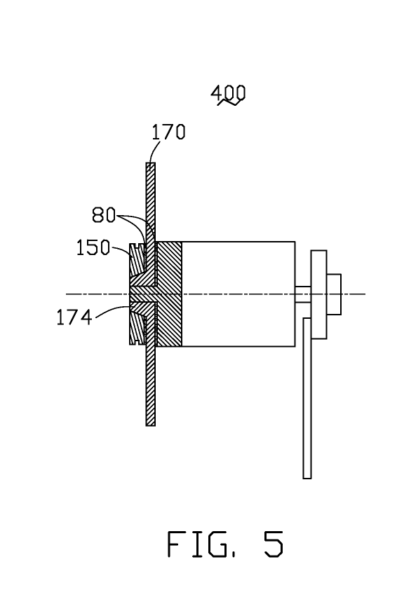

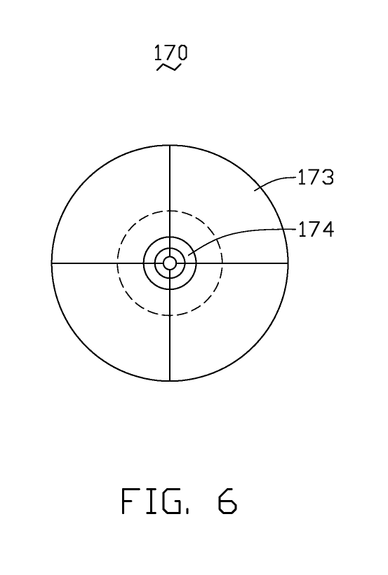

Referring to FIGS. 4-6, a color wheel 300, in accordance with a second preferred embodiment, is similar to the color wheel 200 of the first embodiment. In this embodiment, a color filter 170 includes a mounting ring 174, peripherally extending from the center thereof toward an obstructing plate 150. The obstructing plate 150 defines a tapered opening 151 corresponding to the mounting ring 174. Other configurations of the second embodiment are the same as that of the first embodiment, and so are not described in detail.

In the color wheels, during high-speed rotation of the color wheels, the color filters and the obstructing plates rotate together with the rotating disks and rotating shafts of the motors. If the centrifugal force acting on the contacting borders of the filter sectors is greater than the strength of the adherence between the contacting borders of the filter sectors, the filter sectors cannot radially separate from each other because the color filter are also fixedly positioned between the obstructing plates and the motors.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A color wheel comprising:
a motor having a rotating disk with a side and a rotating shaft protruding from the center of the side thereof;
a color filter comprising a plurality of color sectors adhered to each other, each filter sector including an extending segment, the extending segments extending away from the center of the color filter and cooperating to form a mounting ring with a through hole therein coaxial to the center of the color filter;
an obstructing plate engaged with the color filter and defining an opening corresponding to the mounting ring; wherein
the color filter is positioned between the obstructing plate and the motor.

2. The color wheel as claimed in claim 1, wherein the color filter defines a first surface, a second surface opposite to the first surface, the second surface formed adjacent to the motor, while the first surface faces away from the motor.

3. The color wheel as claimed in claim 2, wherein the diameter of the rotating shaft is equal to that of the through hole of the color filter, while the length of the rotating shaft along the center axis of the rotating disk is equal to that of the through hole.

4. The color wheel as claimed in claim 3, wherein the obstructing plate is ring-shaped and defines a recess formed on the periphery thereof.

5. The color wheel as claimed in claim 4, wherein the diameter of the opening is approximately equal to that of the diameter of the mounting ring.

6. The color wheel as claimed in claim 5, wherein the color filter includes a base plate, the mounting ring extending from the center of the base plate toward the obstructing plate.

7. The color wheel as claimed in claim 6, wherein the mounting ring has a tapered configuration.

8. A color wheel comprising:
a motor having a rotating disk and a rotating shaft protruding from a center of the rotating disk;
a unitary color filter comprising a circular plate portion having a first side and an opposite second side, and a collar portion concentrically formed on the first side of the circular plate portion, the collar portion defining a through hole therethrough with the rotating shaft inserted, from the second side of the circular plate portion to the first side thereof, in the through hole; and
an annular plate engaged with the color filter with the collar portion extending therethrough, the annular plate having a first surface and an opposite second surface proximate to the first side of the circular plate.

9. The color wheel as claimed in claim 8, wherein a distal end of the rotating shaft is flush with a distal end of the collar portion.

10. The color wheel as claimed in claim 8, wherein the rotating shaft terminates at the first surface of the annular plate.
